(19) United States
(12) Patent Application Publication
(10) Pub. No.: US 2021/0089403 A1
(43) Pub. Date: Mar. 25, 2021

(54) METADATA TABLE MANAGEMENT SCHEME FOR DATABASE CONSISTENCY

(71) Applicant: SAMSUNG ELECTRONICS CO., LTD., Suwon-si (KR)

(72) Inventors: Heekwon Park, Cupertino, CA (US); Ho bin Lee, San Jose, CA (US); IIgu Hong, Santa Clara, CA (US); Yang Seok Ki, Palo Alto, CA (US)

(21) Appl. No.: 16/849,846

(22) Filed: Apr. 15, 2020

Related U.S. Application Data
(60) Provisional application No. 62/903,646, filed on Sep. 20, 2019.

(51) Int. Cl. G06F 11/14; G06F 16/22; G06F 16/17; G06F 21/62

(52) U.S. Cl. CPC G06F 11/1435; G06F 11/1464; G06F 11/1469; G06F 2221/0751; G06F 16/1734; G06F 21/6218; G06F 2201/80; G06F 16/2282

(57) ABSTRACT

Provided is a method of database management, the method including locating, with a recovery logic, a first metadata table using a beginning metadata table key, reading, by the recovery logic, the first metadata table, retrieving, with the recovery logic, a first next metadata table key of the first metadata table, locating, by the recovery logic, a second metadata table based on the first next metadata table key or based on a third next metadata table key of a third metadata table having a third metadata table range between a first metadata table range of the first metadata table and a second metadata table range of the second metadata table, reading, by the recovery logic, the second metadata table, determining, by the recovery logic, the second metadata table lacks valid keys in the second metadata table range, and making available, by the recovery logic, memory space associated with the second metadata table.

### CROSS-REFERENCE TO RELATED APPLICATION(S)

This application claims priority to, and the benefit of, U.S. Provisional Application Ser. No. 62/903,646, filed on Sep. 20, 2019, entitled METADATA TABLE MANAGEMENT SCHEME FOR DATABASE CONSISTENCY, the entire contents of which is incorporated herein by reference.

### FIELD

One or more aspects of embodiments of the present disclosure relate generally to data storage by providing a metadata table management scheme for ensuring database consistency.

### BACKGROUND

A key-value solid state drive (KVSSD) may provide a versatile key-value interface at the device level, thereby providing improved performance and simplified storage management, thereby enabling high performance scaling, simplification of a conversion process, and extension of drive capabilities. By incorporating a KV store logic within firmware of the KVSSD, KVSSDs are able to respond to direct data requests from an application while reducing involvement of host software. The KVSSD may use standard SSD hardware that is augmented by using Flash Translation Layer (FTL) software for provides processing capabilities.

### SUMMARY

Embodiments described herein provide improvements to data storage by providing a metadata table management scheme that is able to ensure database consistency.

According to one embodiment of the present disclosure, there is provided a method of database management, the method including locating, with a recovery logic, a first metadata table using a beginning metadata table key, reading, by the recovery logic, the first metadata table, retrieving, with the recovery logic, a first next metadata table key of the first metadata table, locating, by the recovery logic, a second metadata table based on the first next metadata table key or based on a third next metadata table key of a third metadata table having a third metadata table range between a first metadata table range of the first metadata table and a second metadata table range of the second metadata table, reading, by the recovery logic, the second metadata table, determining, by the recovery logic, that the second metadata table lacks valid keys in the second metadata table range, and making available, by the recovery logic, memory space associated with the second metadata table.

The method may further include updating, by the recovery logic, the first metadata table range or the third metadata table range to include the second metadata table range.

The method may further include updating, by the recovery logic, the first next metadata table key or the third next metadata table key to be the same as a second next metadata table key of the second metadata table.

The method may further include making available, by the recovery logic, memory space associated with a fourth metadata table lacking valid keys in a fourth metadata table range thereof, wherein a second next metadata table key of the second metadata table points to the fourth metadata table, and wherein the memory space associated with the fourth metadata table and the memory space associated with the second metadata table are made available in order.

The method may further include allocating, by the recovery logic, the first next metadata table key.

The method may further include storing, by the recovery logic, a first preallocated metadata table key of the first metadata table and the beginning metadata table key in a manifest during termination of the database being managed.

A last metadata table of a chain of metadata tables beginning with the first metadata table may lack a next metadata table key.

The method may further include associating the first metadata table with a write lock to be prevented from being deleted.

According to another embodiment of the present disclosure, there is provided a method of database management, the method including locating, with a recovery logic, a first metadata table having an initial first metadata table range, creating, with the recovery logic, a sub-metadata table having a sub-metadata table range overlapping the initial first metadata table range, and updating, with the recovery logic, the initial first metadata table range to be an updated first metadata table range different than the sub-metadata table range.

The method may further include updating, with the recovery logic, an initial first next metadata table key of the first metadata table to be an updated next metadata table key that is the same as an initial first preallocated metadata table key of the first metadata table.

The method may further include updating, with the recovery logic, the initial first preallocated metadata table key to be an updated first preallocated metadata table key.

The method may further include allocating, with the recovery logic, a second next metadata table key of the sub-metadata table to be the same as an initial first next metadata table key of the first metadata table.

The method may further include storing, by the recovery logic, a first preallocated metadata table key of the first metadata table and a beginning metadata table key in a manifest during termination of the database being managed.

A last metadata table of a chain of metadata tables beginning with the first metadata table may lack a next metadata table key.

The method may further include associating the first metadata table with a write lock to be prevented from being deleted.

According to yet another embodiment of the present disclosure, there is provided A recovery logic for managing a database, the recovery logic being configured to create a chain of metadata tables including a first metadata table and one or more second metadata tables, each of the metadata tables having a next metadata table key pointing to an immediately subsequent one of the metadata tables, store a first preallocated metadata table key of the first metadata table and a beginning metadata table key in a manifest during termination of the database being managed, and determine, upon startup, whether the database has crashed based on whether the manifest is readable.

The recovery logic may be further configured to locate the first metadata table using the beginning metadata table key, read the first metadata table, retrieve a first next metadata table key of the first metadata table, locate the one or more second metadata tables based on the first next metadata table key, read the one or more second metadata tables, determine that an invalid metadata table of the one or more second metadata tables lacks valid keys in a second metadata table range of the invalid metadata table, and make available memory space associated with the invalid metadata table.

The recovery logic may be further configured to update a metadata table range of the first metadata table or of one of the one or more second metadata tables to include the second metadata table range of the invalid metadata table, and update the first next metadata table key of the first metadata table or the next metadata table key of one of the one or more second metadata tables to be the next metadata table key of the invalid metadata table.

The recovery logic may be further configured to locate one of the first metadata table or the one or more second metadata tables having an initial metadata table range, create a sub-metadata table having a sub-metadata table range overlapping the initial metadata table range, and update the initial metadata table range to be an updated metadata table range different than the sub-metadata table range.

The recovery logic may be further configured to update the next metadata table key of one of the first metadata table or the one or more second metadata tables having a metadata table range that immediately precedes a metadata table range of the sub-metadata table to be the same as a previously preallocated metadata table key of the one of the first metadata table or the one or more second metadata tables.

Accordingly, the system of embodiments of the present disclosure is able to improve by data storage by enabling metadata tables to be added, deleted, or split to enable faster search and retrieval of user keys.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram depicting a relationship between various metadata tables of a database according to embodiments of the present disclosure;

FIG. 2 is a block diagram depicting the addition of sub-metadata tables to an existing chain of metadata tables according to embodiments of the present disclosure;

FIG. 3 is a block diagram depicting the deletion of selected metadata tables from an existing chain of metadata tables according to embodiments of the present disclosure;

FIGS. 4A and 4B are a block diagram depicting a method of splitting a main metadata table of an existing chain of metadata tables into a plurality of sub-metadata tables according to embodiments of the present disclosure; and

FIG. 5 is a flow chart depicting a method of database management according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown in order to facilitate a less obstructed view of these various embodiments and to make the description clear.

### DETAILED DESCRIPTION

Features of the inventive concept and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects and features of the present inventive concept to those skilled in the art. Accordingly, processes, elements, and techniques that are not necessary to those having ordinary skill in the art for a complete understanding of the aspects and features of the present inventive concept may not be described.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Metadata tables may be used to keep track of key-value (KV) blocks that have been stored to a KV device (e.g., to a key-value solid state drive (KVSSD)). A metadata table range, or key range, may be set for each metadata table, wherein the respective metadata table ranges of separate metadata tables do not overlap.

To keep track of which KV blocks have been stored to a KV device, a relevant metadata table contains corresponding user keys that fall within the metadata table range that is covered by that particular metadata table.

Accordingly, the user keys may be stored in order within a respective one of the metadata tables. Therefore, each metadata table may have a begin user key for indicating a first key of a metadata table range of that metadata table.

In turn, a plurality of metadata tables may be sorted to be in order according to their respective begin user keys and their respective metadata table ranges.

Embodiments of the present disclosure may provide a method for metadata table management that ensures database consistency. That is, embodiments of the present disclosure provide a method for ensuring accurate data recovery following a database crash or power failure by providing a chain of metadata tables that can be located and accessed even when the crash or power failure occurs during the addition, deletion, or modification of one or more metadata tables of the chain.

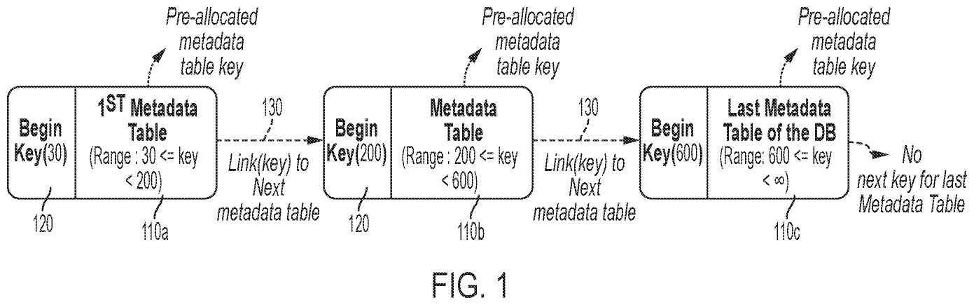

FIG. 1 is a block diagram depicting a relationship between various metadata tables of a database according to embodiments of the present disclosure.

Referring to FIG. 1, as described herein, a plurality of metadata tables of the database may be linked in a chain by having each metadata table (not including a last metadata table in the chain) include therein a link(key)/next metadata table key for indicating the immediately subsequent metadata table in the chain.

One or more metadata tables 110 may be set up during the creation of a database to be linked with a key-value solid state drive (KVSSD). Generally, when creating or initiating a new database, the database may initially have a single initial metadata table 110. However, over time, if a number of keys that are stored in the metadata table 110 increases beyond a given threshold, the initial metadata table 110 may be split into two or more new metadata tables 110 (e.g., two or more sub-metadata tables 110). Thereafter, as the number of keys stored in the sub-metadata tables 110 is increased, the sub-metadata tables 110 may be similarly split further into smaller sub-metadata tables 110 (e.g., sub-metadata tables 110 having a smaller metadata table range/smaller sub-metadata table range), and the process may continue to be repeated to suitably manage the database.

A key for metadata/a metadata table key (e.g., a device key for retrieving a data value corresponding to the metadata), and a begin user key 120 (e.g., a beginning user key within the metadata table) of a metadata table may be stored in a manifest during termination of the database to enable a first metadata table 110a to be located either upon establishing a new database or upon opening an existing database. The manifest may include, for each of the metadata tables, the metadata table key, the begin user keys 120, a beginning and end of a corresponding key range of the user keys, a link(key)/next metadata table key 130 (described further below), a preallocated metadata table key, and user key information.

It may be understood that a metadata key, or metadata table key, may be used to retrieve a given metadata table, and is different from a user key. For example, a beginning metadata table key may indicate the location the first metadata table of a chain of metadata tables. Accordingly, the key of first metadata table (e.g., the beginning metadata table key) may be statically assigned by the system (e.g., a configuration may be established upon initiation or creation of a database). The key may be permanent (e.g., never changed or deleted). Accordingly, if the first metadata table is not deleted, even if the first metadata table does not have any user key, then the first metadata table can be located with the statically assigned beginning metadata table key. That is, the database or recovery logic may always know the key of first metadata table such that the first metadata table can be located.

Accordingly, during database termination, the metadata table key and the begin user key 120 for all metadata tables may be stored in the manifest. The latest version of the metadata tables may be stored (e.g. in the KVSSD) before closing/terminating the database. During database termination, a host system may build the manifest and then store the manifest to KVSSD.

Accordingly, the database can rebuild information regarding a corresponding key range during opening of an existing database. This may be achieved because each metadata table key also has the information of all keys belonging to the metadata table. Accordingly, key information may be retrieved when a user accesses the metadata.

To summarize, the metadata table key and the begin user key 120 may be stored to the manifest (e.g., in a KVSSD) for all metadata during termination of the database (e.g., a host system may build the manifest, and may then store the manifest to the KVSSD). During opening of the database, the manifest may be loaded, and a map corresponding to a key range may be rebuilt. Then, when the user accesses a user key belonging to a metadata table during runtime, the corresponding metadata may be loaded from KVSSD using metadata table key. That is, if a key is inserted, read, or updated in a metadata table, the metadata table will be loaded from KVSSD. Accordingly, keys can be added to metadata table during runtime, and a modified metadata table may be updated periodically. Before opening the database, the manifest and metadata tables have been stored in KVSSD. During an initial status following opening of the database, the manifest may be deleted after building metadata table information in the host system.

For example, if an existing database is to be opened, the existing database attempts to read the manifest including the metadata table keys and the begin user key 120 for all existing metadata table. In some embodiments, the first metadata table 110a may be protected (e.g., may have a write lock associated therewith) such that the first metadata table 110a is not necessarily deleted even when the first metadata table 110a has no keys therein. That is, the first metadata table 110a may be protected to ensure recovery following a database crash or power failure, as the starting metadata table 110a may be needed during a recovery operation.

However, unlike a write-ahead log-less (WAL-less) device, which stores information of the begin user key whenever the begin user key is changed, information about the begin metadata table 110a need not be stored according to some embodiments of the present disclosure. Instead, an operation of storing begin metadata information can be omitted, and the begin metadata table 110a may not be deleted, such that recovery logic can begin a recovery operation by starting at the begin metadata table 110a.

If the disclosed systems determine that the manifest does not exist, or if the disclosed systems determine that the manifest cannot be read or found, then the first metadata table 110a created during initiation of the database may be read. However, if the manifest is able to be read successfully, such that the metadata table key and the begin user key 120 of the all metadata tables 110 may be obtained, the manifest may be deleted. Accordingly, whether the manifest is able to be read may indicate whether the database has crashed (e.g., if the manifest is unable to be read, it may be determined that the database crashed, but if a manifest is able to be read, it may be determined that the database has shutdown correctly).

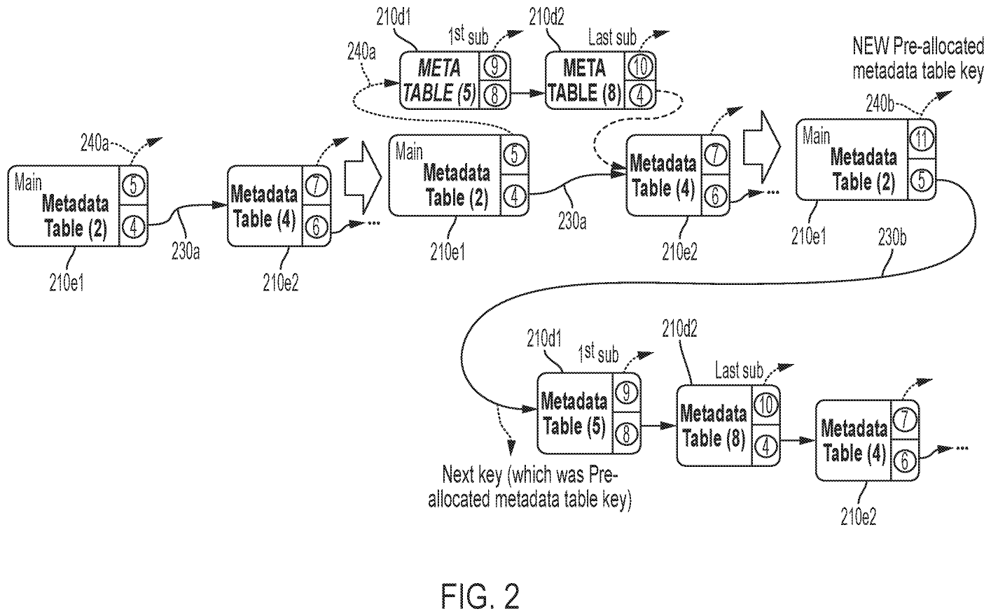

The metadata tables 110 may include a link(key) 130 (e.g., a next metadata table key, or “next key”) that points to another metadata table 110 to thereby link consecutive or adjacent metadata tables 110. When a database is created, a first metadata table 110a may be established. As described below with respect to FIG. 2, if the number of user keys in the first metadata table 110a increases to exceed a threshold, a subsequent metadata table 110a may be created by splitting the first metadata table 110a.

The first metadata table 110a may include a next metadata table key 130 that points to a subsequent metadata table 110b. The subsequent metadata table 110b may also include a next metadata table key 130 to link to a next metadata table 110c, and so on. Ultimately, a last metadata table (e.g., the next metadata table 110c in the present example) in a chain of metadata tables 110 may omit any next metadata table key 130.

Accordingly, by successfully reading the manifest to obtain the metadata table key and the begin user key 120 of the first metadata table 110a, because of linked nature of the metadata tables 110 of the database, all of the metadata tables 110 of a chain may be located and accessed in the event of a crash. That is, if the manifest is successfully read, there is no need to read a subsequent metadata table 110 that is linked to the first metadata table 110a using the chain, as the manifest effectively already has all metadata table information (e.g., the begin user key 120 and the metadata table key), but the chain mechanism described herein enables the reading of the metadata tables 110 by using chain in a recovery operation.

FIG. 2 is a block diagram depicting the addition of sub-metadata tables to an existing chain of metadata tables according to embodiments of the present disclosure.

Referring to FIG. 2, in managing a plurality of metadata tables 210, one or more new metadata tables 210d may be added between two (previously) consecutive metadata tables 210e. However, if an unexpected power outage or system crash occurs while adding metadata tables 210 (or while deleting metadata tables), database consistency may be corrupted.

Accordingly, according to embodiments of the present disclosure, when managing the metadata tables 210, the established first metadata table (e.g., the first metadata table 110a of FIG. 1, or a main metadata table 210e1 of FIG. 2) may be protected such that the first metadata table is prevented from being deleted.

As described herein, the first metadata table 110a may be the metadata table 110 that is selected for protected from deletion. That is, a first metadata table may continually exist such that a recovery logic of the database may start from the first metadata table during a recovery process. Should the first metadata table be deleted, the recovery logic may be effectively lost upon startup, as the recovery logic may have no effective way of knowing where a chain of metadata tables 210 begins.

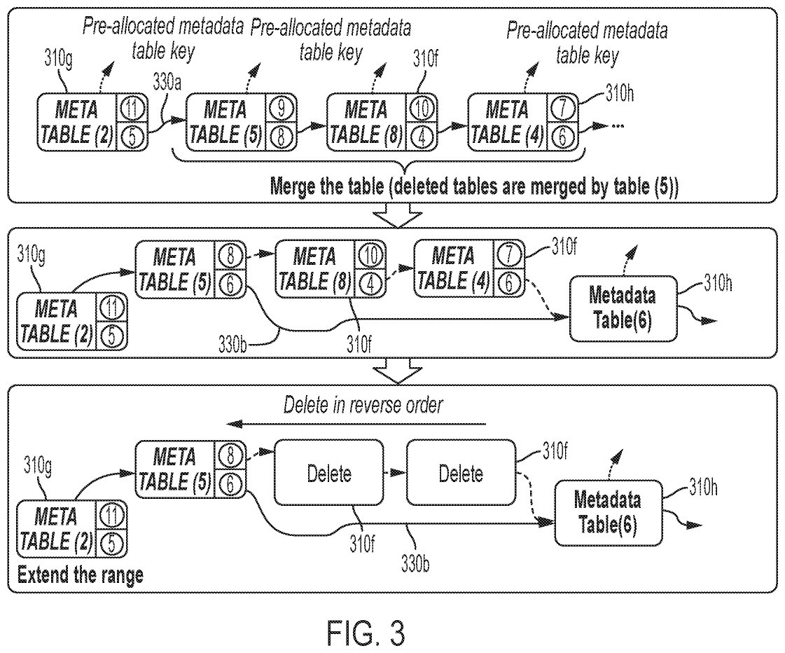

As described below with respect to FIG. 3, metadata table deletion may occur when a metadata table 210 becomes empty (e.g., when there is no user key in the metadata table). However, the first metadata table 110a might not be deleted even if the first metadata table 110a does not have any user key, because the first metadata table 110a is a starting point of a recovery operation. Further, in a split case of the present example described with respect to FIG. 2, the main metadata table 210e1 that is split has multiple user keys, as the main metadata table 210e1 conducts a split operation when a number of keys in the main metadata table 210e1 exceeds a threshold, noting that one or more user keys may remained in the main metadata table 210e1. Accordingly, the main metadata table 210e1 may not be deleted naturally, but not for reasons corresponding to the protection of the first metadata table 110a.

If management of the metadata tables 210 includes splitting a metadata table into two or more sub-metadata tables, a write order may be established by first demarcating a first sub-metadata table 210d1, any intermediary sub-metadata table(s), and a last sub-metadata table 210d2 (in the example shown in FIG. 2, two sub-metadata tables 210d1 and 210d2 are created).

The first sub-metadata table 210d1 may use a preallocated metadata table key of the main metadata table 210e1, and the first sub-metadata table 210d1 may have two new user keys as a result of the spilt operation—one user key for the next sub-metadata table's key, and another user key for a preallocated metadata table key. Also, a very last sub-metadata table 210d2 may have one new key for preallocated metadata table as a result of the split operation, and the next metadata table key may be the same as the next metadata table key of main metadata table 210e1. Thereafter, the main metadata table 210e1 may be updated. It should be noted that the split operation of the present example can be performed on any metadata table 210 where a number of user keys exceeds a corresponding threshold.

Accordingly, because of the “create and update” sequence described above, some embodiments of the present disclosure enable the metadata table to be recovered from a crash occurring during metadata table splitting. During the recovery operation, the metadata table 210 may be retrieved, then there may be an attempt to receive a sub-metadata table 210d using a preallocated metadata key. If the sub-metadata table 210d exists, then an entirety of the sub-metadata table may be deleted. If the sub-metadata table 210d does not exist, then the initial metadata table 210 may be ignored, a next metadata table 210 may be retrieved, and the recovery operation may be repeated.

A procedure that is similar to the above described split operation may be followed when adding a metadata table 210. For example, the main metadata table 210e1 may initially correspond to an initial metadata table range that (after creation of the sub-metadata tables 210d1 and 210d2) corresponds to both an updated metadata table range of the updated main metadata table 210e1 and sub-metadata table range(s) of the newly created sub-metadata tables 210d1 and 210d2. That is, a range of a combination of the updated metadata table range and the sub-metadata table range(s) may be the same as the initial metadata table range of the main metadata table 210e1.

Further, the initial next metadata table key 230a of the main metadata table 210e1, which initially pointed to a last metadata 210e2 in the present example, may be updated to be the initial preallocated metadata table key 240a to point to the first, newly created sub-metadata table 210e1. Furthermore, the initial preallocated metadata table key 240a of the main metadata table 210e1 may be updated to a new preallocated metadata table key 240b.

FIG. 3 is a block diagram depicting the deletion of selected metadata tables from an existing chain of metadata tables according to embodiments of the present disclosure.

Referring to FIG. 3, in managing a plurality of metadata tables 310, one or more metadata tables 310f may be deleted to free up memory and device space. As previously mentioned, each metadata table 310 can have a metadata table range, or key range. If one or more metadata tables 310 have no key in the metadata table range of that metadata table 310, and assuming that none of the metadata tables 310 is a first metadata table (e.g., the first metadata table 110a of FIG. 1, or the main metadata table 210 of FIG. 2), then the one or more metadata tables 310 may be deleted (e.g., in the present example, the metadata tables 310f may be deleted).

As few as a single metadata table 310 may be deleted, or multiple consecutive metadata tables 310f may be deleted in the same operation. For example, if multiple consecutive metadata tables 310f have no key within their respective corresponding metadata table ranges, the last valid metadata table 310g in a chain of metadata tables may cause the multiple consecutive metadata tables 310f to be deleted. The last valid metadata table 310g is a metadata table 310 that has valid keys in its metadata table range, and that is immediately before a first one of the multiple consecutive metadata tables 310f having no key within its corresponding metadata table range. In some embodiments, a metadata table merge may be triggered by a metadata table 310f having no valid keys. When updating a metadata table 310, it may be determined whether the next consecutive metadata table(s) 310 have any valid key or not.

That is, each metadata table 310 contains keys in a given metadata table range. When one or more metadata tables 310f have no keys corresponding to their respective metadata table range, or otherwise lacks a valid key, those metadata tables 310f are able to be deleted, or may be merged with another adjacent metadata table (e.g., metadata table 310g) still having keys within its metadata table range. That is, the remaining adjacent metadata table 310g may have its metadata table range expanded to further include the metadata table range of one or more of the deleted metadata tables 310f.

Accordingly, the previous metadata table 310g, with which the one or more deleted metadata tables 310f are merged, can be updated to cover the respective metadata table ranges of the deleted metadata tables 310f. In this manner, the term “merge” may refer to the merger of metadata table ranges of adjacent metadata tables 310. Further, an initial next metadata table key 330a of the remaining adjacent metadata table 310g may be updated to an updated next metadata table key 330b to point to the metadata table 310h immediately following the last metadata table 310f in the chain that is to be deleted instead of pointing to the first metadata table 310f in the chain to be deleted.

Thereafter, the consecutive metadata tables 310f may be deleted in reverse order, such that the metadata table 310f that immediately follows the remaining adjacent metadata table 310g is deleted last. Accordingly, following a crash, the recovery logic is able to read of the undeleted metadata tables 310, regardless of what metadata table additions or deletions have occurred prior to the crash.

For example, referring to FIG. 1, following a crash, the recovery logic can determine the metadata table key of the first metadata table 110a, and is therefore able to first read the first metadata table 110a. Thereafter, by using the next metadata table key 130 in the first metadata table 110a, and along with any respective next metadata table key 130 of any subsequent metadata table(s) 110b (with the exception of the last metadata table 110c), the recovery logic can traverse the metadata tables 110.

When the recovery logic finds a given metadata table 110 by using a metadata table key, that metadata table 110 may be deleted. Then, updated user keys remain in a user key recovery range, as opposed to a metadata table recovery range.

However, if a crash occurs while deleting/merging metadata tables (e.g., while deleting the metadata tables 310f shown in FIG. 3), upon beginning recovery, the recovery logic may either delete sub-metadata tables 110 in order until finding a metadata table 110 having an invalid next metadata table key 130 (e.g., an invalid metadata table), or may delete sub-metadata tables 110 until a next metadata table key 130 points to a main metadata table 210e1. Similarly, if a crash occurs while adding metadata tables (e.g., while adding the metadata tables 210d shown in FIG. 2), the recovery logic either may delete sub-metadata tables 110 until a next metadata table key 130 points to a main metadata table 210e1, or may delete sub-metadata tables 110 until the next metadata table key 130 is invalid.

The recovery logic may either find sub-metadata tables 110 until finding a metadata table 110 having an invalid next metadata table key 130 (e.g., until finding a metadata table having a key that does not exist in the system/KVSSD), or may find sub-metadata tables 110 until a next metadata table key 130 is the same as the next metadata table key 130 of a main metadata table 210e1. After all sub-metadata tables 110 are found, the sub-metadata tables 110 are deleted in reverse order to ensure database consistency even in the event a crash occurs during recovery.

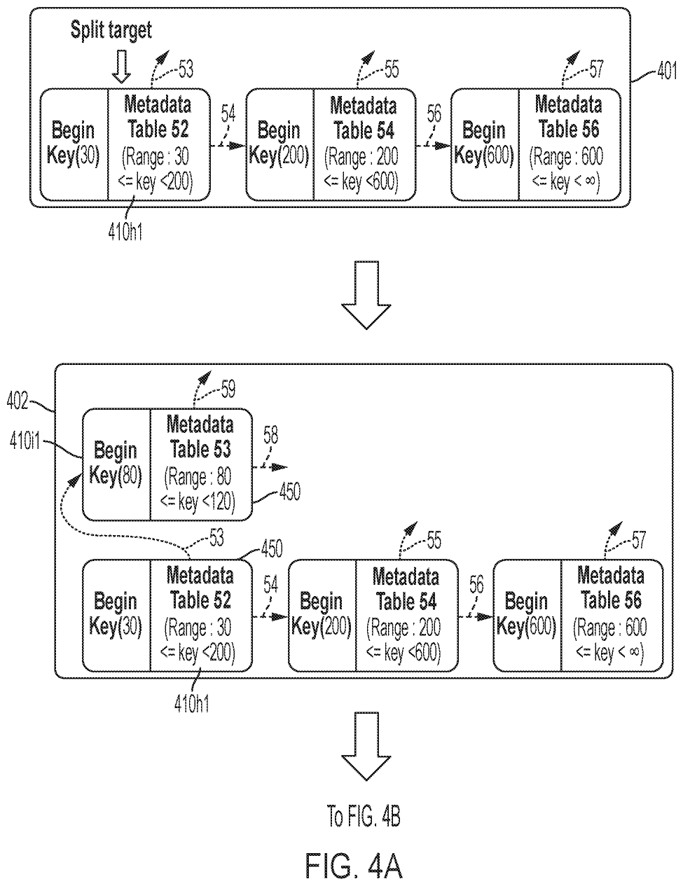

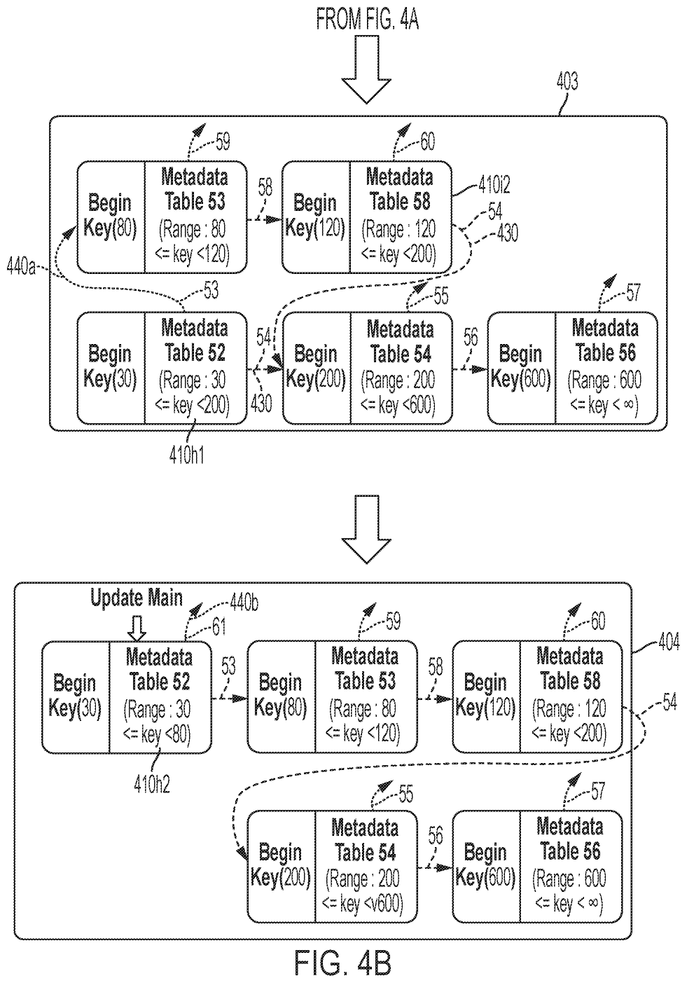

FIGS. 4A and 4B are a block diagram depicting a method of splitting a main metadata table of an existing chain of metadata tables into a plurality of sub-metadata tables according to embodiments of the present disclosure.

Referring to FIGS. 4A and 4B, in another example, and as described above, at (401), a main metadata table 410h may be chosen as a split target. As described below, the main metadata table 410h may be split to generate one or more additional separate sub-metadata tables 410i to reduce a number of keys per metadata table 410. For example, a new sub-metadata table(s) 410i may be added to be effectively inserted between two existing metadata tables 410 by splitting the first metadata table 410h.

At (402), a first sub-metadata table 410i1 may be written. The first sub-metadata table 4100 may have a metadata table range 450 that is within the metadata table range of the original main metadata table 410h1.

At (403), a second sub-metadata table 410i2 may be written in order. That is, the next metadata table key 430 of a last sub-metadata table 410i2 may be the same as that of the original main metadata table 410h1. Further, the metadata table range 450 of the last sub-metadata table 410i2 may be from immediately after the end of the metadata table range 450 of the previous sub-metadata table 4100 to the end of the metadata table range 450 of the original main metadata table 410h1.

At (404), the original main metadata table 410h1 may be updated to be an updated main metadata table 410h2. For example, the metadata table range 450 of the main metadata table 410h1 may be updated to not overlap the metadata table ranges 450 of the newly generated sub-metadata table(s) 410i. Further, the next metadata table key 430 (e.g., key 54 in the present example) is changed by a preallocated table key 440a (e.g., key 53 in the present example). Thereafter, a new preallocated table key 440b may be assigned (e.g., key 61 in the present example).

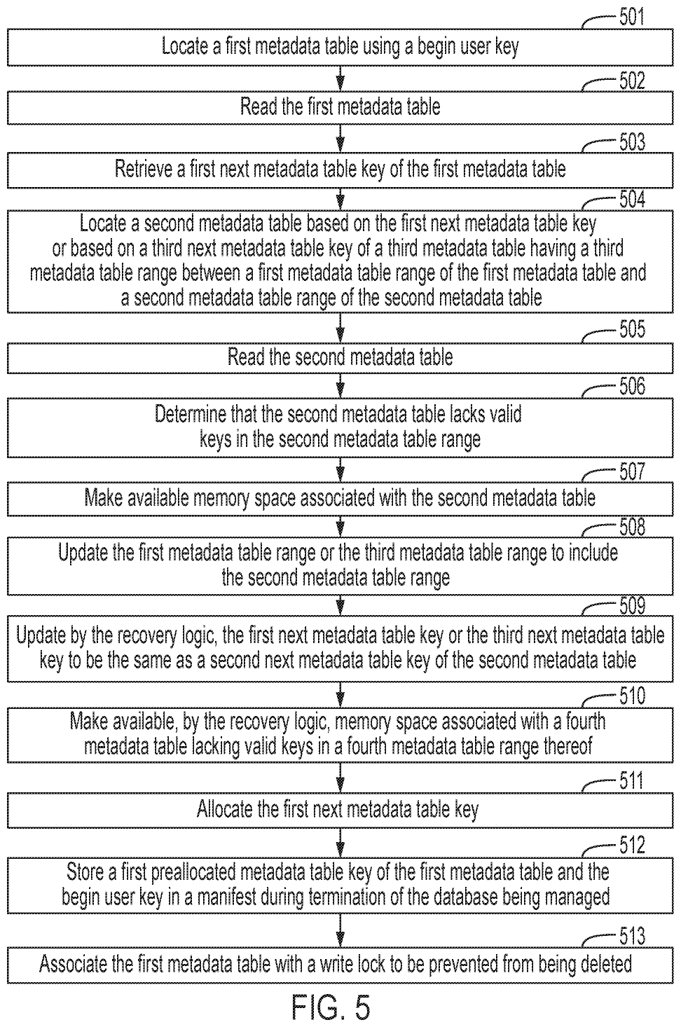

FIG. 5 is a flow chart depicting a method of database management according to some embodiments of the present disclosure.

Referring to FIG. 5, the method of database management shown may be performed by a recovery logic module.

At 501, a first metadata table may be located using a begin user key. At 502, the first metadata table may be read. At 503, a first next metadata table key of the first metadata table may be retrieved. At 504, a second metadata table may be located based on the first next metadata table key or based on a third next metadata table key of a third metadata table having a third metadata table range between a first metadata table range of the first metadata table and a second metadata table range of the second metadata table. At 505, the second metadata table may be read. At 506, it may be determined that the second metadata table lacks valid keys in the second metadata table range. At 507, memory space associated with the second metadata table may be made available. A last metadata table of a chain of metadata tables beginning with the first metadata table may lack a next metadata table key.

At 508, the first metadata table range or the third metadata table range may be updated to include the second metadata table range.

At 509, the first next metadata table key or the third next metadata table key may be updated to be the same as a second next metadata table key of the second metadata table.

At 510, memory space associated with a fourth metadata table lacking valid keys in a fourth metadata table range thereof may be made available. A second next metadata table key of the second metadata table may point to the fourth metadata table.

The memory space associated with the fourth metadata table and the memory space associated with the second metadata table may be made available in order.

At 511, the first next metadata table key may be allocated.

At 512, a first preallocated metadata table key of the first metadata table and the begin user key may be stored in a manifest during termination of the database being managed.

At 513, the first metadata table may be associated with a write lock to be prevented from being deleted.

Accordingly, as described above, embodiments of the present disclosure obviate the need to write a metadata table update log for tracking which metadata tables were in the process of being updated during a crash. Embodiments of the present disclosure also provide a simple method for reading the metadata tables during a recovery process by simply starting at a first metadata table, and reading all relevant metadata tables in order by using a next table key stored in all of the remaining metadata tables (except for a last metadata table). Further, metadata tables rendered irrelevant may be deleted, and existing metadata tables may be split to improve database manageability.

While the present disclosure has been particularly shown and described with reference to some example embodiments thereof, it will be understood by those of ordinary skill in the art that various changes in form and details may be made therein without departing from the spirit and scope of the present disclosure as set forth in the following claims and their equivalents.

What is claimed is:

1. A method of database management, the method comprising:
locating, with a recovery logic, a first metadata table using a beginning metadata table key;
reading, by the recovery logic, the first metadata table;
retrieving, with the recovery logic, a first next metadata table key of the first metadata table;
locating, by the recovery logic, a second metadata table based on the first next metadata table key or based on a third next metadata table key of a third metadata table having a third metadata table range between a first metadata table range of the first metadata table and a second metadata table range of the second metadata table;
reading, by the recovery logic, the second metadata table;
determining, by the recovery logic, that the second metadata table lacks valid keys in the second metadata table range; and
making available, by the recovery logic, memory space associated with the second metadata table.

2. The method of claim 1, further comprising updating, by the recovery logic, the first metadata table range or the third metadata table range to include the second metadata table range.

3. The method of claim 1, further comprising updating, by the recovery logic, the first next metadata table key or the third next metadata table key to be the same as a second next metadata table key of the second metadata table.

4. The method of claim 1, further comprising making available, by the recovery logic, memory space associated with a fourth metadata table lacking valid keys in a fourth metadata table range thereof,
wherein a second next metadata table key of the second metadata table points to the fourth metadata table, and
wherein the memory space associated with the fourth metadata table and the memory space associated with the second metadata table are made available in order.

5. The method of claim 1, further comprising allocating, by the recovery logic, the first next metadata table key.

6. The method of claim 1, further comprising storing, by the recovery logic, a first preallocated metadata table key of the first metadata table and the beginning metadata table key in a manifest during termination of the database being managed.

7. The method of claim 1, wherein a last metadata table of a chain of metadata tables beginning with the first metadata table lacks a next metadata table key.

8. The method of claim 1, further comprising associating, by the recovery logic, the first metadata table with a write lock to be prevented from being deleted.

9. A method of database management, the method comprising:
locating, with a recovery logic, a first metadata table having an initial first metadata table range;
creating, with the recovery logic, a sub-metadata table having a sub-metadata table range overlapping the initial first metadata table range; and
updating, with the recovery logic, the initial first metadata table range to be an updated first metadata table range different than the sub-metadata table range.

10. The method of claim 9, further comprising updating, with the recovery logic, an initial first next metadata table key of the first metadata table to be an updated next metadata table key that is the same as an initial first preallocated metadata table key of the first metadata table.

11. The method of claim 10, further comprising updating, with the recovery logic, the initial first preallocated metadata table key to be an updated first preallocated metadata table key.

12. The method of claim 9, further comprising allocating, with the recovery logic, a second next metadata table key of the sub-metadata table to be the same as an initial first next metadata table key of the first metadata table.

13. The method of claim 9, further comprising storing, by the recovery logic, a first preallocated metadata table key of the first metadata table and a beginning metadata table key in a manifest during termination of the database being managed.

14. The method of claim 9, wherein a last metadata table of a chain of metadata tables beginning with the first metadata table lacks a next metadata table key.

15. The method of claim 9, further comprising associating the first metadata table with a write lock to be prevented from being deleted.

16. A recovery logic for managing a database, the recovery logic being configured to:
create a chain of metadata tables comprising a first metadata table and one or more second metadata tables, each of the metadata tables having a next metadata table key pointing to an immediately subsequent one of the metadata tables;
store a first preallocated metadata table key of the first metadata table and a beginning metadata table key in a manifest during termination of the database being managed; and
determine, upon startup, whether the database has crashed based on whether the manifest is readable.

17. The recovery logic of claim 16, wherein the recovery logic is further configured to:
locate the first metadata table using the beginning metadata table key;
read the first metadata table;
retrieve a first next metadata table key of the first metadata table;
locate the one or more second metadata tables based on the first next metadata table key;
read the one or more second metadata tables;
determine that an invalid metadata table of the one or more second metadata tables lacks valid keys in a second metadata table range of the invalid metadata table; and
make available memory space associated with the invalid metadata table.

18. The recovery logic of claim 17, wherein the recovery logic is further configured to:
update a metadata table range of the first metadata table or of one of the one or more second metadata tables to include the second metadata table range of the invalid metadata table; and
update the first next metadata table key of the first metadata table or the next metadata table key of one of the one or more second metadata tables to be the next metadata table key of the invalid metadata table.

19. The recovery logic of claim 16, wherein the recovery logic is further configured to:
locate one of the first metadata table or the one or more second metadata tables having an initial metadata table range;
create a sub-metadata table having a sub-metadata table range overlapping the initial metadata table range; and
update the initial metadata table range to be an updated metadata table range different than the sub-metadata table range.

20. The recovery logic of claim 19, wherein the recovery logic is further configured to update the next metadata table key of one of the first metadata table or the one or more second metadata tables having a metadata table range that immediately precedes a metadata table range of the sub-metadata table to be the same as a previously preallocated metadata table key of the one of the first metadata table or the one or more second metadata tables.
